(19) United States
(12) Patent Application Publication
(10) Pub. No.: US 2016/0303792 A1
(43) Pub. Date: Oct. 20, 2016

(54) MANUFACTURING METHOD AND MANUFACTURING APPARATUS FOR HOLLOW BODY

(71) Applicants: TOYOTA JIDOSHA KABUSHIKI KAISHA, Toyota-shi, Aichi-ken (JP); FTS CO., LTD., Toyota-city, Aichi-pref. (JP)

(72) Inventors: Yuji KARASAKI, Miyoshi-shi (JP); Takuya SHIMOKAWA, Okazaki-shi (JP)

(73) Assignees: TOYOTA JIDOSHA KABUSHIKI KAISHA, Toyota-shi, Aichi-ken (JP); FTS CO., LTD., Toyota-city, Aichi-pref. (JP)

(21) Appl. No.: 15/100,656

(22) PCT Filed: Nov. 24, 2014
(86) PCT No.: PCT/IB2014/002779

§ 371 Date: Jun. 1, 2016

(30) Foreign Application Priority Data
Dec. 10, 2013 (JP) 2013-255353

(51) Int. Cl. B29C 51/26; B29C 51/42; B29C 51/02; B29C 51/10; B29C 47/00; B29C 47/08

(52) U.S. Cl. CPC B29C 51/267; B29C 47/0019; B29C 47/0054; B29C 47/0866; B29C 51/02; B29C 51/10; B29C 51/262; B29C 51/264; B29C 51/421; B29C 51/261; B29L 2031/7172

(57) ABSTRACT

A sheet body extruded from an extruding die is mounted on conveyers immediately and thereby drawdown and the like is inhibited or prevented to suppress deflection in the thickness, length and the like of the sheet body. Further, the conveyers include a heater inside thereof and thereby reduction of the temperature of the sheet body can be inhibited or prevented by heating by means of the heater. As a result, productivity of the hollow body is improved.

### BACKGROUND OF THE INVENTION

1. Field of the Invention

The present invention relates to a manufacturing method and a manufacturing apparatus for a hollow body.

2. Description of Related Art

To blow-mold a hollow body, as described in Japanese Patent Application Publication No. 9-1640 (JP 9-1640 A), for example, it has been proposed that a cylindrical parison extruded from an ejection port of a head is cut out into a sheet-like state, the sheet-like parison is held in a U-shaped state by holding a front end and a rear end of the sheet-like parison and a hollow body is molded by clamping together molds.

Further, Published Japanese Translation of PCT Application No. 2010-530818 (JP 2010-530818 A) is also found as a related document.

In case of the JP 9-1640 A, there is a possibility that the front end side of the sheet-like parison may be drawn down by the time when the rear end side thereof is extruded so that the thickness and length of the parison may change.

It has been demanded to inhibit reduction in yield of molten resin (sheet body) due to such drawdown.

### SUMMARY OF THE INVENTION

The present invention provides a manufacturing method and a manufacturing apparatus for a hollow body to improve yield.

An aspect of the present invention includes: extruding sheet-like molten resin from an extruding die; mounting the sheet-like molten resin extruded from the extruding die on a planar receiving base; shaping the sheet-like molten resin on an upper mold and a lower mold; and molding the hollow body joining together the sheet-like molten resin shaped on the upper mold and the lower mold.

According to the manufacturing method for the hollow body, the sheet-like molten resin extruded from the extruding die is mounted (supported) on a planar receiving base. As a result, drawdown or the like of the sheet-like molten resin is inhibited and thereby a change in the shape of the sheet-like molten resin is inhibited.

The manufacturing method for the hollow body may further include, after the sheet-like molten resin is mounted on the planar receiving base, cutting and separating the sheet-like molten resin in a static state.

According to the manufacturing method for the hollow body, after the sheet-like molten resin extruded from the extruding die is supported by a planar receiving base, the sheet-like molten resin is cut in the static state. For example, the sheet-like molten resin having a unified length corresponding to the upper mold and the lower mold is extruded, then, mounted on the planar receiving base and cut to two pieces for the upper mold and the lower mold in the static state. Because the sheet-like molten resin is cut in the static state in this way, its cut state is excellent thereby improving yield of the sheet-like molten resin.

In the manufacturing method for the hollow body, when cutting and separating the sheet-like molten resin in the static state, the sheet-like molten resin may be cut in a state in which the sheet-like molten resin is shaped on the upper mold and the lower mold.

In the manufacturing method for the hollow body, a single sheet-like molten resin is cut to pieces for the upper mold and the lower mold in a state in which the sheet-like molten resin is shaped on the upper mold and the lower mold. Because in this case, the sheet-like molten resin is not only static but also shaped on the molds, the sheet-like molten resin can be cut more stably. As a result, yield of the sheet-like molten resin is improved.

In the manufacturing method for the hollow body, when the sheet-like molten resin is cut and separated in the static state, the sheet-like molten resin may be cut on the planar receiving base.

In the manufacturing method for the hollow body, the sheet-like molten resin mounted on the planar receiving base is cut. That is, by cutting the molten resin extruded from the extruding die in a state in which it is mounted on the planar receiving base immediately, the molten resin can be cut stably thereby improving yield of the sheet-like molten resin.

According to the manufacturing method for the hollow body, the sheet-like molten resin mounted on the planar receiving base may have a unified length corresponding to the upper mold and the lower mold and the sheet-like molten resin may be held at two positions, the two positions being a front end of the sheet-like molten resin in an extrusion direction and a rear end of the sheet-like molten resin in the extrusion direction, and the sheet-like molten resin may be carried to the upper mold and the lower mold.

According to the manufacturing method for the hollow body, the sheet-like molten resin having the unified length corresponding to the upper mold and the lower mold mounted on the planar receiving base is held at the front end of the sheet-like molten resin in the extrusion direction and the rear end of the sheet-like molten resin in the extrusion direction and the sheet-like molten resin is carried to the upper mold and the lower mold. Thus, the two portions are the front end of the sheet-like molten resin in the extrusion direction and the rear end of the sheet-like molten resin in the extrusion direction are unavailable for molding, so that yield is improved compared to a case of transportation by holding the front end and the rear end of each of the two sheet-like molten resins for the upper mold and the lower mold.

In the manufacturing method for the hollow body, the unified length corresponding to the upper mold and the lower mold may be a length of the sheet-like molten resin mounted from an end portion of the upper mold to an end portion of the lower mold prior to shaping.

In the manufacturing method for the hollow body, the upper mold and the lower mold may be arranged adjacent to each other and the upper mold and the lower mold may be clamped together by turning any one of the upper mold and the lower mold.

In the manufacturing method for the hollow body, when the sheet-like molten resin is mounted on the planar receiving base, the sheet-like molten resin mounted on the planar receiving base may be heated by a heater.

In the manufacturing method for the hollow body, after the sheet-like molten resin is extruded from the extruding die, the sheet-like molten resin is mounted on the planar receiving base temporarily. Thus, there is a possibility that the temperature of molten resin may drop on the planar receiving base thereby causing a failure in molding.

However, in the manufacturing method for the hollow body, the sheet-like molten resin mounted on the planar receiving base may undergo no reduction in temperature because it is heated by the heater, thereby inhibiting generation of a failure in molding.

In the manufacturing method for the hollow body, the extruding die and the planar receiving base are moved relative to each other at the same speed as an extrusion speed of the molten resin.

In the manufacturing method for the hollow body, because the extruding die and the planar receiving base are moved relative to each other at the same speed as the extrusion speed of the sheet-like molten resin, the sheet-like molten resin is mounted on the planar receiving base without overlapping each other.

Another aspect of the present invention includes an extruding die extruding sheet-like molten resin; a planar receiving base on which the sheet-like molten resin extruded from the extruding die is mounted; a transportation mechanism carrying the sheet-like molten resin mounted on the planar receiving base; an upper die molding the sheet-like molten resin carried by the transportation mechanism; and a lower mold molding the sheet-like molten resin carried by the transportation mechanism.

In the manufacturing apparatus for the hollow body, the sheet-like molten resin extruded from the extruding die is mounted on the planar receiving base and carried to the upper mold and the lower mold from the planar receiving base by the transportation mechanism to mold the hollow body. Because as described above, the sheet-like molten resin extruded from the extruding die is mounted on the planar receiving base, drawdown or the like of the sheet-like molten resin is inhibited.

In the manufacturing apparatus for the hollow body, the planar receiving base may be a belt conveyer.

Because in the manufacturing apparatus for the hollow body, the planar receiving base on which the sheet-like molten resin extruded from the extruding die is mounted is the belt conveyer, the sheet-like molten resin extruded continuously by driving the belt conveyer is mounted on the belt conveyer without overlapping each other.

In the manufacturing apparatus for the hollow body, the planar receiving base may further include a heater heating the sheet-like molten resin.

In the manufacturing apparatus for the hollow body, after the sheet-like molten resin is extruded from the extruding die, the sheet-like molten resin is mounted on the planar receiving base temporarily. Thus, there is a possibility that the temperature of the molten resin may lower on the planar receiving base thereby causing a failure in molding. However, because in the manufacturing apparatus for the hollow body, the sheet-like molten resin mounted on the planar receiving base is heated by the heater, the sheet-like molten resin undergoes no reduction in temperature thereby inhibiting generation of a failure in molding.

The manufacturing apparatus of the hollow body may further include a cutting portion configured to cut the sheet-like molten resin mounted on the planar receiving base.

The manufacturing apparatus for the hollow body cuts the sheet-like molten resin mounted on the planar receiving base. That is, by cutting the molten resin extruded from the extruding die in a state in which it is mounted on the planar receiving base immediately, the molten resin can be cut stably thereby improving yield of the sheet-like molten resin.

The manufacturing apparatus for the hollow body may further include a cutting portion configured to cut the sheet-like molten resin shaped on the upper mold and the lower mold.

In the manufacturing apparatus for the hollow body, a single sheet-like molten resin is cut by the cutting portion in a state in which it is shaped on the upper mold and the lower mold. Because in this case, the sheet-like molten resin is not only static but also shaped on the upper mold and the lower mold, it can be cut more stably. As a result, yield is improved.

In the manufacturing apparatus for the hollow body, the transportation mechanism may hold a front end of the sheet-like molten resin in the extrusion direction and a rear end of the sheet-like molten resin in the extrusion direction, the sheet-like molten resin being mounted on the planar receiving base.

In the manufacturing apparatus for the hollow body, the sheet-like molten resin mounted on the planar receiving base is carried to the upper mold and the lower mold with holding the front end of the sheet-like molten resin in the extrusion direction and the rear end of the sheet-like molten resin in the extrusion direction. Thus, portions unavailable for molding are only two portions, the two portions being the front end of the sheet-like molten resin in the extrusion direction and the rear end of the sheet-like molten resin in the extrusion direction, and thereby yield is improved.

For example, when a single sheet-like molten resin of a unified length corresponding to the upper mold and the lower mold is carried with the front end and the rear end in the extrusion direction held, the held portion is reduced and thereby yield is improved compared to a case of transportation by holding the front end and the rear end of each of the two sheet-like molten resins for the upper mold and the lower mold.

Because the aspect of the present invention has the above-described structure, yield of the sheet-like molten resin can be improved and thereby productivity of the hollow body can be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory diagram showing extruding step and mounting step of a manufacturing method for a hollow body according to a first embodiment of the present invention;

FIG. 2 is a plan view for explaining a carrying state of the manufacturing method for the hollow body according to the first embodiment of the present invention;

FIG. 3 is an explanatory diagram of a major portion in a state prior to shaping in shaping step of the manufacturing method for the hollow body according to the first embodiment of the present invention;

FIG. 4 is an explanatory diagram of the major portion in a state after shaping in shaping step of the manufacturing method for the hollow body according to the first embodiment of the present invention;

FIG. 5 is an explanatory diagram of the state after shaping in molding step of the manufacturing method for the hollow body according to the first embodiment of the present invention;

FIG. 6 is an explanatory diagram of a mold clamping state in molding step of the manufacturing method for the hollow body according to the first embodiment of the present invention;

FIG. 7 is an explanatory diagram of a mold opening state in molding step of the manufacturing method for the hollow body according to the first embodiment of the present invention;

FIG. 8 is an explanatory diagram of a product unloading state in molding step of the manufacturing method for the hollow body according to the first embodiment of the present invention;

FIG. 9 is an explanatory diagram showing extruding step and mounting step in the manufacturing method for the hollow body according to a second embodiment of the present invention; and

FIG. 10 is an explanatory diagram of a mold opening state in molding step in the manufacturing method for the hollow body according to a third embodiment of the present invention.

### DETAILED DESCRIPTION OF EMBODIMENTS

### First Embodiment

A manufacturing apparatus of a hollow body according to the first embodiment of the present invention will be described and a manufacturing method of the hollow body using the same manufacturing apparatus of the hollow body will be described. In the meantime, in the present embodiment, a case where the hollow body to be manufactured is a resin fuel tank for vehicles will be described. Drawings for use here are represented schematically.

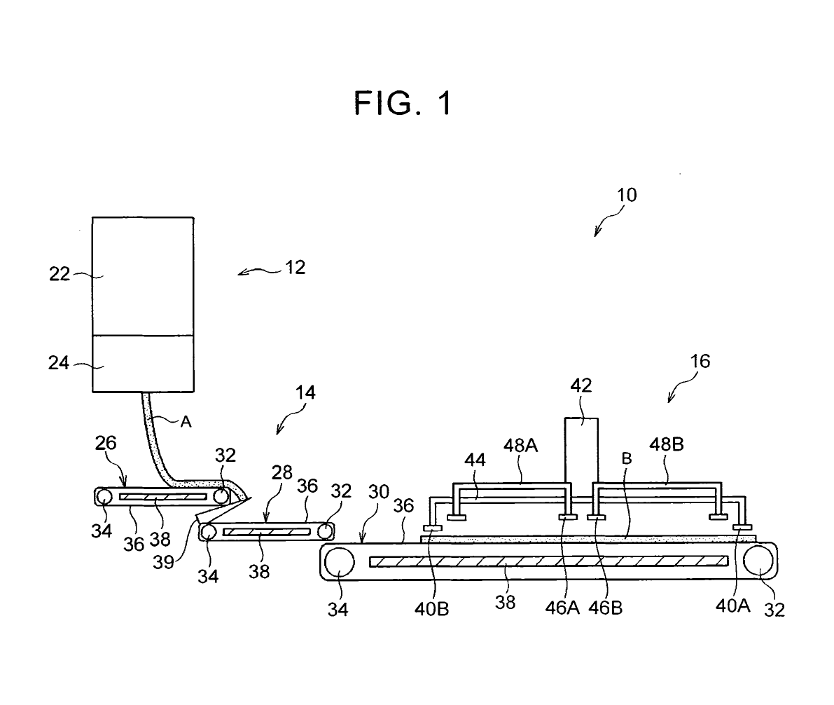

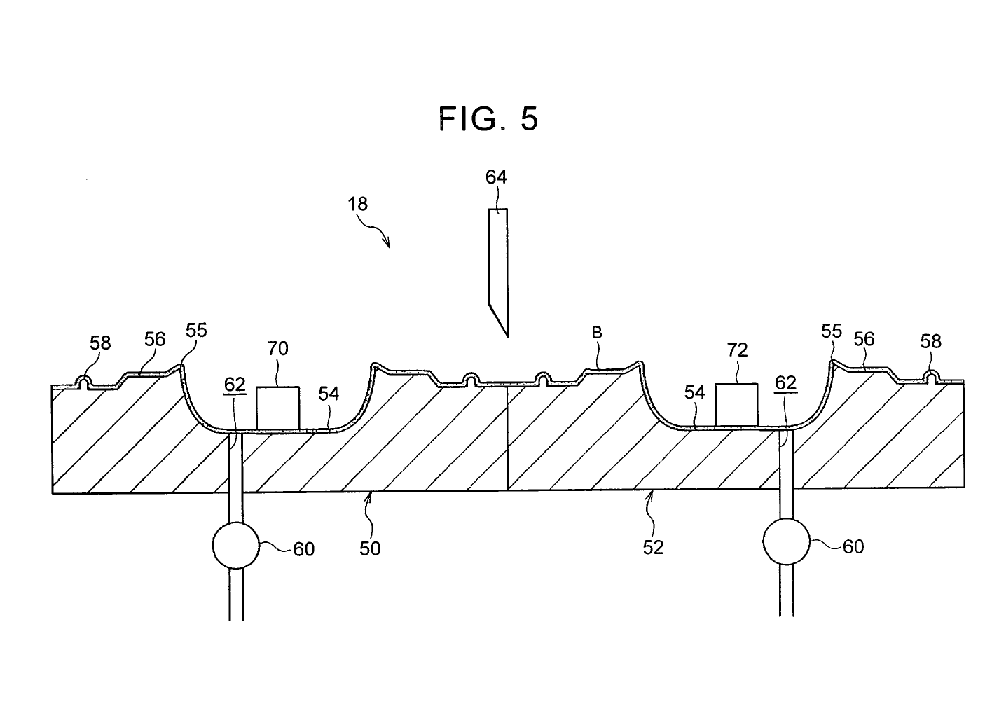

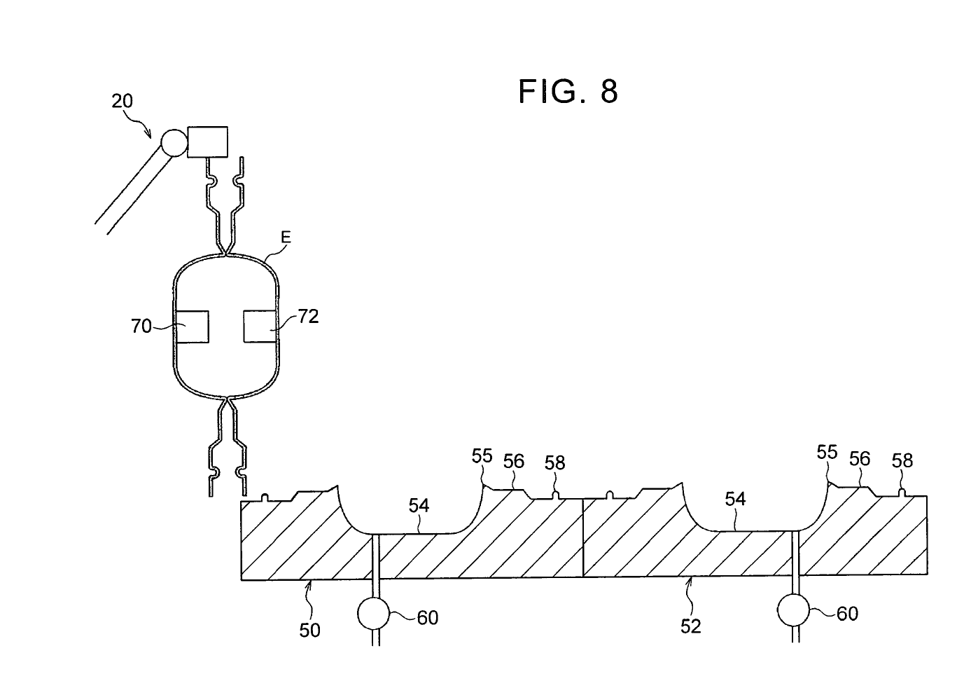

The manufacturing apparatus 10 for the hollow body is basically constituted of an extruding die 12 configured to extrude sheet-like molten resin (hereinafter referred to as “sheet body” depending on cases) A as shown in FIG. 1, a conveyer mechanism 14 on which the sheet body A extruded from the extruding die 12 is mounted, a transportation apparatus 16 configured to carry the sheet body A mounted on the conveyer mechanism 14 to a mold described later, a mold 18 (see FIG. 5) configured to mold the sheet body A carried by the transportation apparatus 16 to a hollow body (resin fuel tank), and an unloading apparatus 20 (see FIG. 8) configured to unload the molded resin fuel tank from the mold 18.

As shown in FIG. 1, the extruding die 12 includes a die core 22 configured to transform the molten resin to a sheet-like condition and an adjusting portion 24 configured to adjust the thickness and width of the molten resin transformed to the sheet-like condition. Thus, the extruding die 12 adjusts the molten resin after transformed to the sheet-like condition by the die core 22 to a predetermined thickness and width by the adjusting portion 24 and extrudes sheet-like molten resin onto the conveyer mechanism 14.

As shown in FIG. 1, the conveyer mechanism 14 includes a conveyer 26 arranged just below the extruding die 12, a conveyer 28 arranged on the downstream side in the carrying direction of the conveyer 26 and below the conveyer 26 with their end portions overlapped with each other as seen in a plan view, and a conveyer 30 arranged on the downstream side in the carrying direction of the conveyer 28 and below the conveyer 28 with their end portions overlapped with each other as seen in a plan view. Each of the conveyers 26, 28, 30 includes a drive roller 32, a driven roller 34, a belt 36 which is provided between the drive roller 32 and the driven roller 34, the sheet body A being mounted on the belt 36, and a heater 38 arranged inside the belt 36. Further, the drive rollers 32 of the respective conveyers 26, 28, 30 are driven at the same speed as an extrusion speed of the sheet body A of the extruding die 12.

The “same speed” mentioned here refers to a speed which allows the sheet body A arriving at the top of the conveyer 26 from the extruding die 12 to be carried successively from the conveyer 26 onto the belt 36 of the conveyer 30 via the conveyer 28 without overlapping on the belt 36.

Further, a cutter 39 capable of advancing/retracting with respect to the carried sheet body A is arranged between the conveyer 26 and the conveyer 28. The cutter 39 is adapted to cut the sheet body A extruded from the extruding die 12 to a unified length corresponding to an upper mold 50 and a lower mold 52 described later. Hereinafter, the sheet body A cut to the unified length is referred to as sheet body B.

In the meantime, the “unified length” refers to a length of the sheet body B which extends from an end portion of the upper mold 50 up to an end portion of the lower mold 52 prior to shaping when a single sheet body B is shaped on the upper mold 50 and the lower mold 52 described later (see the sheet body B of FIGS. 1 and 5).

Further, the conveyer 30 is longer than the conveyers 26 and 28 and designed with a length capable of carrying the entire sheet body B which is the unified length.

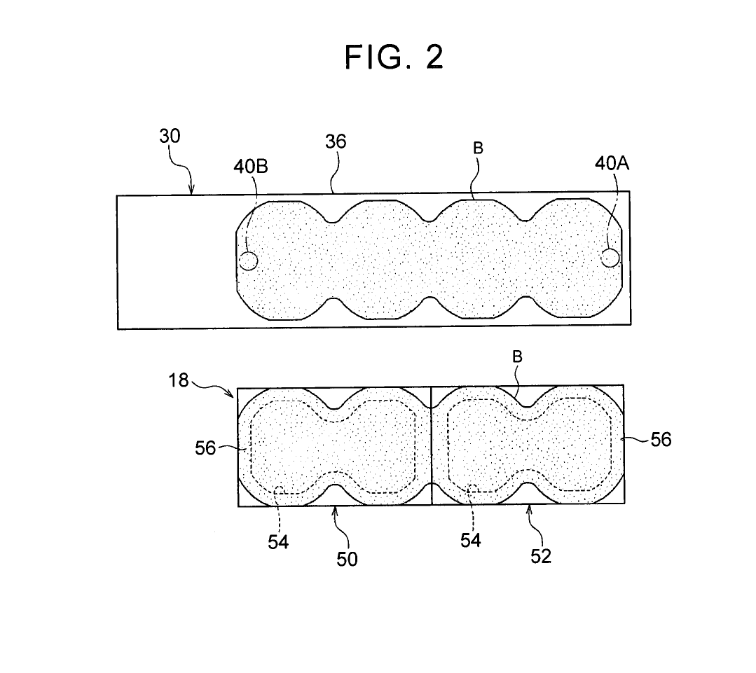

The transportation apparatus 16 carries the sheet body B from the top of the conveyer 30 onto the mold 18 arranged adjacent the transportation apparatus 16 by a moving mechanism (not shown). As shown in FIGS. 1 and 2, suction pads 40A, 40B for carrying the front end of the sheet body B in the extrusion direction and the rear end of the sheet body B in the extrusion direction by suction, is supported by a supporting body 44, and a negative pressure supplying source 42 for applying a negative pressure to the suction pads 40A, 40B, is supported by the supporting body 44. As shown in FIG. 1, pressing frames 46A, 46B are supported by supporting bodies 48A, 48B, pressing frames 46A, 46B press the sheet body B to the upper mold 50 and the lower mold 52 described later when the carried sheet body B is shaped on the mold 18. The supporting bodies 44, 48A, 48B are constructed to be movable vertically by each independent driving mechanism (not shown).

As shown in FIG. 5, the mold 18 includes the upper mold 50 and the lower mold 52 configured to hollow-mold a resin fuel tank and the upper mold 50 and the lower mold 52 are arranged adjacent to each other such that mold clamping is enabled by turning the lower mold 52 by 180°. Each of the upper mold 50 and the lower mold 52 includes a molding portion 54 which is a recess for molding the resin fuel tank, an outer peripheral portion 56 located on the outer peripheral side of the molding portion 54 and a projecting portion 58 for shaping, the projecting portion 58 being formed with protrusion around a planar portion of the outer peripheral portion 56.

In the meantime, although the upper mold 50 and the lower mold 52 according to the present embodiment are of a type which clamps molds vertically, the upper mold and the lower mold of the present invention are not restricted to this example, but includes a type which clamps the molds in a horizontal direction, for example.

Further, as shown in FIG. 5, a hole portion 62 which communicates with a negative pressure supplying source 60 is formed so as to bring the sheet body B into close contact with the molding portion 54 (shaping) by applying a negative pressure to the molding portion 54.

Further, a cutter 64 is provided above the mold 18, the cutter 64 cutting the sheet body B being shaped integrally on the upper mold 50 and the lower mold 52 between the upper mold 50 and the lower mold 52. In the meantime, the cutter 64 is arranged to be capable of advancing/retracting with respect to the mold 18.

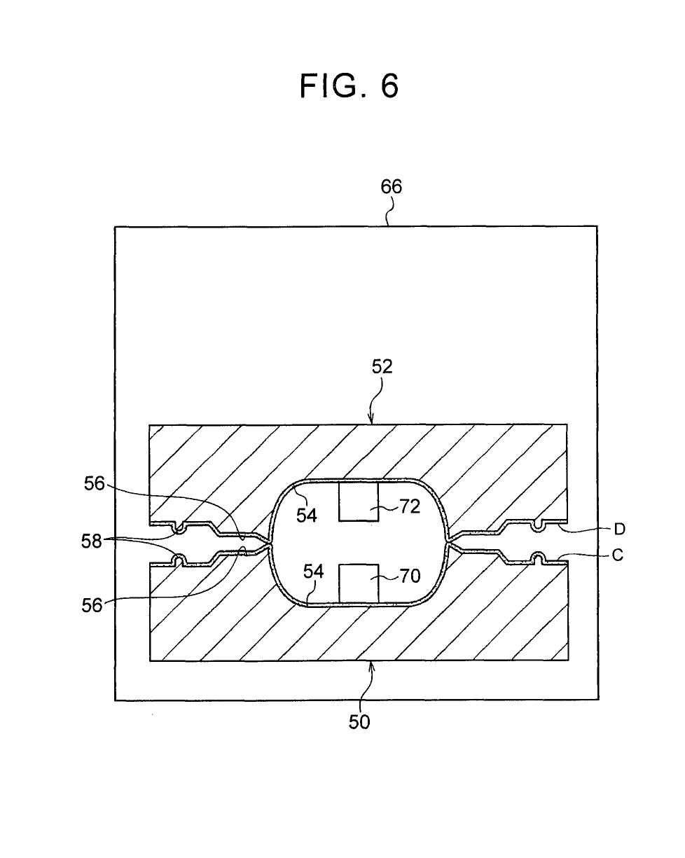

Further, the manufacturing apparatus 10 for the hollow body includes an inverting apparatus 66 configured to clamp the lower mold 52 and the lower mold 52 by arranging the lower mold 52 on the upper mold 50 as shown in FIG. 6.

The manufacturing apparatus 10 includes an unloading apparatus 20 configured to unload a completed molded body (resin fuel tank) E from the mold 18, which is opened after molding and cooling within the clamped inverting apparatus 66 (see FIG. 8).

The manufacturing method for the resin fuel tank using the manufacturing apparatus 10 for the hollow body having such a structure will be described.

As shown in FIG. 1, molten resin which has been formed into a sheet-like state by the die core 22 of the extruding die 12 is adjusted to a predetermined thickness and width by the adjusting portion 24 and the molten resin is extruded onto the conveyer 26 of the conveyer mechanism 14 as the sheet body A.

At this time, the conveyers 26, 28, 30 are driven at the same speed as the extrusion speed of the extruding die 12. Thus, the sheet body A which has arrived at the top of the belt 36 of the conveyer 26 from the extruding die 12 is carried successively from the conveyer 26 onto the belt 36 of the conveyer 30 via the conveyer 28 without overlapping on the belt 36.

The sheet body A is cut by the cutter 39 at the unified length corresponding to the upper mold 50 and the lower mold 52 of the mold 18, the cutter 39 being provided between the conveyer 26 and the conveyer 28. When the cut sheet body B is carried to a predetermined position (below the transportation apparatus 16) on the belt 36 of the conveyer 30, driving of the conveyer 30 (drive roller 32) is stopped.

With respect to the sheet body B stopped at the predetermined position on the belt 36 of the conveyer 30, the supporting body 44 of the transportation apparatus 16, the supporting body 44 being located above the sheet body B, descends to the sheet body B side and the suction pads 40A, 40B, a negative pressure is applied from the negative pressure supplying source 42 to the suction pads 40A, 40B, are brought into contact with the sheet body B. As a result, the suction pads 40A, 40B hold the front end and the rear end of the sheet body B.

With this state, the transportation apparatus 16 ascends the supporting body 44 and the transportation apparatus 16 moves the sheet body B from above the conveyer 30 to above the mold 18 (upper mold 50 and lower mold 52) (see FIG. 2).

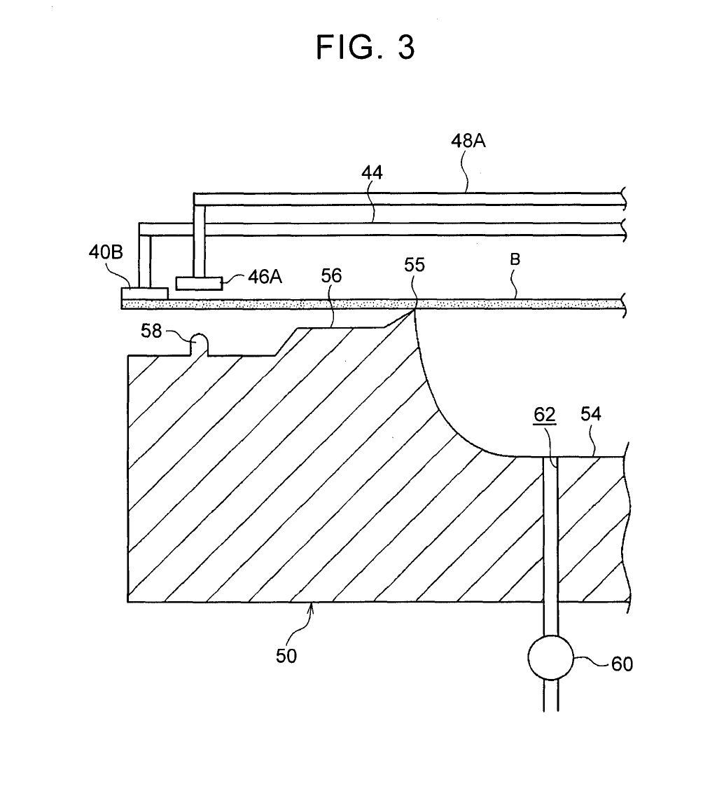

As shown in FIG. 3, the transportation apparatus 16 which has arrived at the top of the mold 18 descends the supporting body 44 to a position where the sheet body B makes contact with a projection 55 which is an end portion of the molding portion 54.

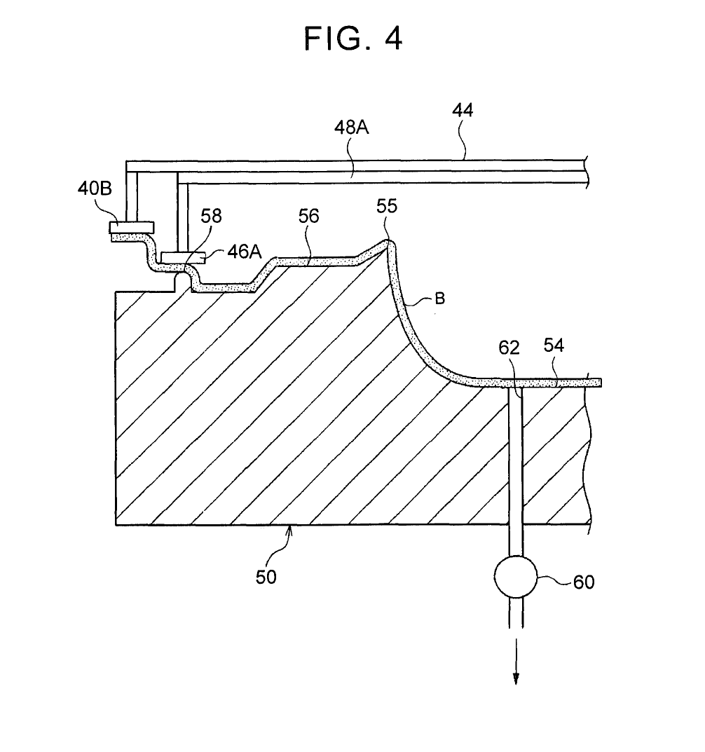

Subsequently, as shown in FIG. 4, the supporting bodies 48A, 48B are lowered to press the sheet body B downward of a line connecting the suction pads 40A, 40B and the projection 55 so that the pressing frames 46A, 46B comes into contact with the projecting portions 58 of the upper mold 50 and the lower mold 52. When the negative pressure supplying source 60 is driven with this state, a negative pressure is applied to the sheet body B inside of each projecting portion 58 so that the sheet body B is brought into close contact with the molding portion 54 and the outer peripheral portion 56 inside of each projecting portion 58 of the upper mold 50 and the lower mold 52 (see FIG. 4).

Subsequently, when the action of the negative pressure from the negative pressure supplying source 42 to the suction pads 40A, 40B is stopped, the suction pads 40A, 40B are separated from the sheet body B and the transportation apparatus 16 is brought back to above the conveyer 30.

With this state, as shown in FIG. 5, incorporated components 70, 72 are arranged inside the sheet body B located in the molding portion 54 of each of the upper mold 50 and the lower mold 52 with a jig (not shown).

In a state in which the sheet body B is shaped on the upper mold 50 and the lower mold 52 as described above, the sheet body B is cut by the cutter 64 to a sheet body C for the upper mold and a sheet body D for the lower mold.

Subsequently, the upper mold 50 and the lower mold 52 are moved to the position of the inverting apparatus 66, and inside the inverting apparatus 66 the lower mold 52 is arranged on the upper mold 50 and those molds are clamped together (see FIG. 6).

After that, the sheet bodies C, D are welded inside the inverting apparatus 66 and after that, cooled to form the molded body (resin fuel tank) E.

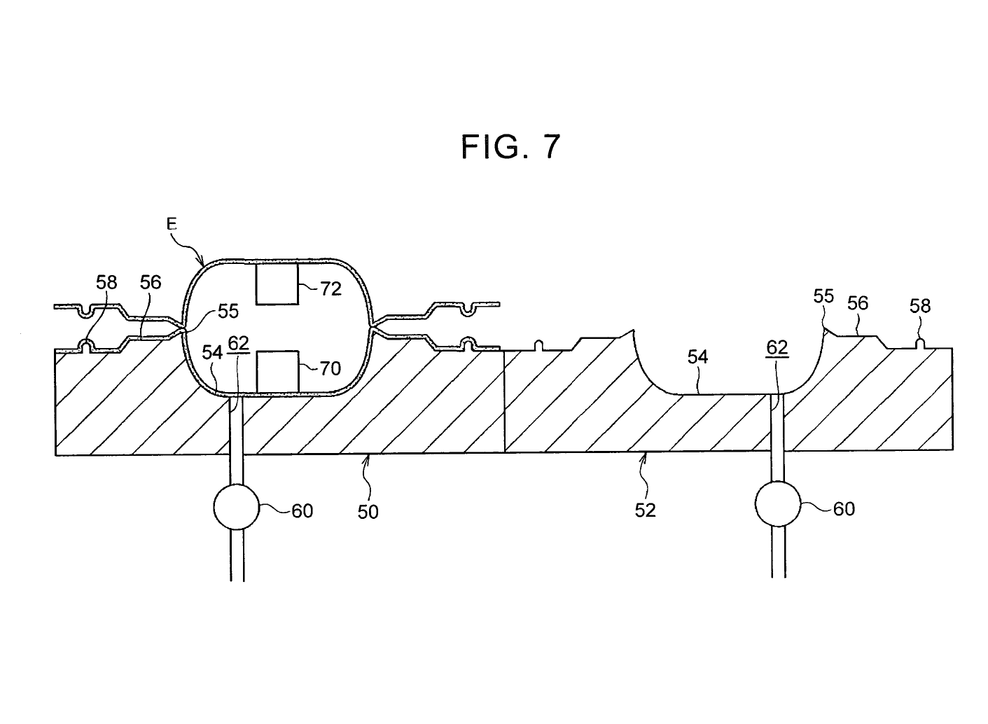

After the molded product E is cooled sufficiently, the mold is opened and the molded product E adhering to the upper mold 50 side is separated and unloaded by the unloading apparatus 20 (see FIGS. 7 and 8).

According to the manufacturing method of the hollow body using such a manufacturing apparatus 10 for the hollow body, the sheet body A of molten resin extruded from the extruding die 12 is mounted (supported) on the belt 36 of the conveyer 26 immediately. As a result, the sheet body A can be inhibited from being drawn down. Further, it is possible to inhibit or prevent the sheet body for the upper mold from being drawn down or falling inside during waiting for the sheet body for the lower mold to be extruded while holding the sheet body for the upper mold, like a type in which the sheet body A is cut to a piece for the upper mold 50 and a piece for the lower mold 52 at the time of extrusion from the extruding die 12. That is, a change in the shape (planar shape, thickness, length and the like) of the sheet body A can be inhibited. As a result, yield of the sheet body can be improved.

Further, because the conveyers 26, 28, 30 are driven at the same speed as the extrusion speed for the sheet body A, the sheet bodies A extruded continuously never overlap each other and are carried by the belt 36 of each of the conveyers 26, 28, 30. Thus, even in a structure which supports the sheet bodies A, B and the like by the conveyers 26, 28, 30, reduction in yield of the sheet bodies A, B can be prevented.

The conveyers 26, 28, 30 include further a heater 38 below their belts 36. Thus, the sheet bodies A to D mounted on the belt 36 can be heated. Thus, it is possible to inhibit or prevent the temperature of the sheet bodies A to D on the conveyers 26, 28, 30 from lowering to cause a failure in molding.

In the meantime, the “heating” may be heating for recovery of a lowered temperature (bringing back to the temperature in which extrusion occurs) or may be a heating for raising the temperature to a higher temperature than at the time of extrusion.

Further, because the sheet body B is cut in a state in which it is vacuum shaped (in a static state) on the upper mold 50 and the lower mold 52 by the cutter 64, it can be cut stably thereby improving yield of the molded product E.

In the meantime, the “cutting in a static state” refers to cutting the sheet body in a stopped state while being supported by a receiving base or the like.

Further, until the sheet body is carried up to the mold 18, it is carried as a single sheet body B used for the upper mold 50 and the lower mold 52. Thus, a portion which becomes unavailable due to suction is only the front end of the sheet body B in the extrusion direction and the rear end of the sheet body B in the extrusion direction and thereby yield of the molded product E is improved.

Particularly, if two sheet bodies C, D are provided separately for the upper mold 50 and the lower mold 52, the front end and the rear end of each of the sheet bodies C, D are held by suction so that four portions become unavailable. However, the unavailable portions in this case are only two, thereby productivity being improved.

### Second Embodiment

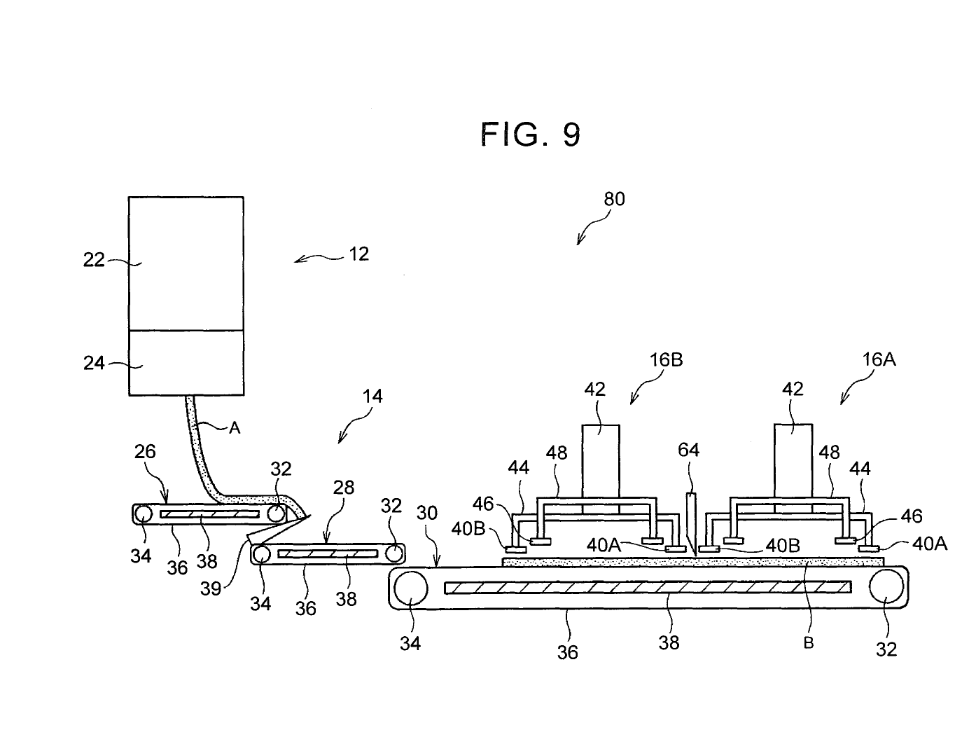

A manufacturing apparatus and a manufacturing method for the hollow body according to the second embodiment of the present invention will be described with reference to FIG. 9. Like reference numerals are attached to identical components to the first embodiment and description thereof including its manufacturing method is omitted.

A manufacturing apparatus 80 for the hollow body includes a cutter 64 configured to cut the sheet body B to a piece for the upper mold 50 and a piece for the lower mold 52 on its conveyer 30.

Further, transportation apparatuses 16A, 16B configured to carry the sheet bodies C, D cut by the cutter 64 are provided above the conveyer 30. Each of the transportation apparatuses 16A, 16B includes suction pads 40A, 40B to hold the front end and the rear end of each of the sheet bodies C, D by suction and carry the sheet bodies C, D to above the upper mold 50 and the lower mold 52.

In the manufacturing apparatus 80 for the hollow body having such a structure, the sheet body B stopped at a predetermined position on the belt 36 of the conveyer 30 is cut by the cutter 64 so that it is separated to the sheet body C for the upper mold 50 and the sheet body D for the lower mold 52. The respective sheet bodies C, D are carried to above the upper mold 50 and the lower mold 52 by the suction pads 40A, 40B of the transportation apparatuses 16A, 16B.

Because as described above, the sheet body B is supported on the belt 36 of the conveyer 30 and cut to the sheet bodies C, D in the static state, reduction in yield due to cutting failure is inhibited or prevented and thereby productivity of the resin fuel tank is improved.

In the meantime, although according to the present embodiment, the transportation apparatuses 16A, 16B are provided for each of the sheet bodies. C, D, it is permissible to provide only the transportation apparatus 16A and carry the sheet bodies C, D to the mold 18 successively.

### Third Embodiment

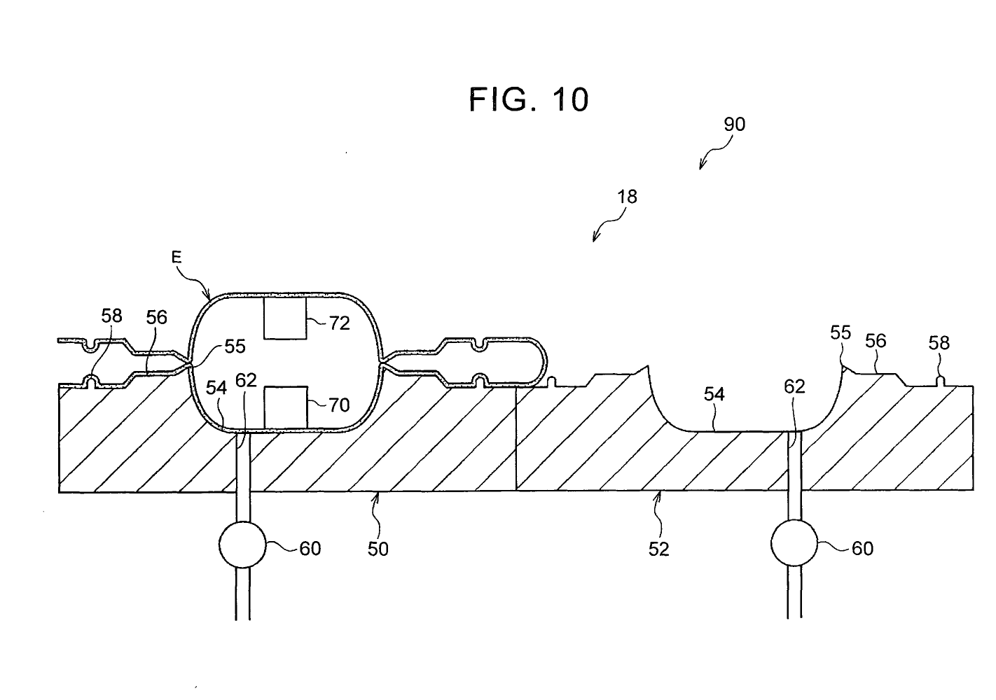

A manufacturing apparatus and a manufacturing method for the hollow body according to the third embodiment of the present invention will be described with reference to FIG. 10. Like reference numerals are attached to identical components to the first embodiment and description thereof including its manufacturing method is omitted.

In a manufacturing apparatus 90 for the hollow body, the molded product E is manufactured without cutting the sheet body B to the end (see FIG. 10). By manufacturing the molded product E without cutting the sheet body B until the molded product E is completed, reduction in yield due to cutting can be avoided and thereby the productivity of the resin fuel tank can be improved.

In the meantime, although in the series of the embodiments, the die core 22 of the extruding die 12 is configured to mold molten resin into the sheet-like state, cylindrical molten resin (so-called parison) may be formed and opened into the sheet-like state or may be formed into the sheet-like state by divided flows.

Further, although in the series of the embodiments, the sheet body B or the sheet bodies C, D are carried from the conveyer 30 to the mold 18-by suction by the suction pads 40A, 40B, they may be carried by being held with a clamp.

Further, although in the series of the embodiments, the sheet bodies A, B extruded from the extruding die 12 are supported by the conveyers 26, 28, 30, they may be supported by other planar base. In the meantime, the planar base such as the conveyer is not limited to a horizontal one like in the series of the embodiments, but may be an inclined one.

Further, although in the series of the embodiments, the conveyer 26 and the like are driven at the same speed as the extrusion speed of the extruding die 12, a relative speed between the extruding die 12 and a receiving base such as the conveyer 26 may be the same speed as the extrusion speed. Further, the relative speed may be different from the extrusion speed.

Further, although in the series of the embodiments, the cutting by the cutter 64 aims at separating the sheet body B of the unified length to the sheet bodies C, D for the upper mold 50 and the lower mold 52, it is not restricted to this example. Even other cuttings have an effect of improving yield by cutting stably.

Further, although in the series of the embodiments, the manufacturing methods and the manufacturing apparatuses for the resin fuel tank have been described, they can be applied to a manufacturing method and a manufacturing apparatus for other hollow body.

1-16. (canceled)

17. A manufacturing method for a hollow body comprising:
extruding sheet-like molten resin from an extruding die;
mounting the sheet-like molten resin extruded from the extruding die on a planar receiving base;
shaping the sheet-like molten resin on an upper mold and a lower mold; and
molding the hollow body by joining together the sheet-like molten resin shaped on the upper mold and the lower mold.

18. The manufacturing method for the hollow body according to claim 17, further comprising
after the sheet-like molten resin is mounted on the planar receiving base, cutting and separating the sheet-like molten resin in a static state.

19. The manufacturing method for the hollow body according to claim 18, wherein
when the sheet-like molten resin is cut and separated in the static state, the sheet-like molten resin is cut in a state in which the sheet-like molten resin is shaped on the upper mold and the lower mold.

20. The manufacturing method for the hollow body according to claim 18, wherein
when the sheet-like molten resin is cut and separated in the static state, the sheet-like molten resin is cut on the planar receiving base.

21. The manufacturing method for the hollow body according to claim 17, wherein
the sheet-like molten resin mounted on the planar receiving base has a unified length corresponding to the upper mold and the lower mold and the sheet-like molten resin is held at two positions, the two positions being a front end of the sheet-like molten resin in an extrusion direction and a rear end of the sheet-like molten resin in the extrusion direction, and the sheet-like molten resin is carried to the upper mold and the lower mold.

22. The manufacturing method for the hollow body according to claim 21, wherein
the unified length corresponding to the upper mold and the lower mold is a length of the sheet-like molten resin mounted from an end portion of the upper mold to an end portion of the lower mold prior to shaping.

23. The manufacturing method for the hollow body according to claim 17, wherein
the upper mold and the lower mold are arranged adjacent to each other and the upper mold and the lower mold are clamped together by turning any one of the upper mold and the lower mold.

24. The manufacturing method for the hollow body according to claim 17, wherein
when the sheet-like molten resin is mounted on the planar receiving base, the sheet-like molten resin mounted on the planar receiving base is heated by a heater.

25. The manufacturing method for the hollow body according to claim 17, wherein
the extruding die and the planar receiving base are moved relative to each other at the same speed as an extrusion speed of the molten resin.

26. The manufacturing method for the hollow body according to claim 17, wherein
the planar receiving base is a conveyer.

27. A manufacturing apparatus for a hollow body comprising:
an extruding die extruding sheet-like molten resin;
a planar receiving base on which the sheet-like molten resin extruded from the extruding die is mounted;
a transportation mechanism carrying the sheet-like molten resin mounted on the planar receiving base;
an upper mold molding the sheet-like molten resin carried from the planar receiving base by the transportation mechanism; and
a lower mold molding the sheet-like molten resin carried from the planar receiving base by the transportation mechanism.

28. The manufacturing apparatus for the hollow body according to claim 27, wherein
the planar receiving base is a belt conveyer.

29. The manufacturing apparatus for the hollow body according to claim 27, wherein
the planar receiving base includes a heater heating the sheet-like molten resin.

30. The manufacturing apparatus for the hollow body according to claim 27, further comprising
a cutting portion configured to cut the sheet-like molten resin mounted on the planar receiving base.

31. The manufacturing apparatus for the hollow body according to claim 27, further comprising
a cutting portion configured to cut the sheet-like molten resin which is shaped on the upper mold and the lower mold.

32. The manufacturing apparatus for the hollow body according to claim 27, wherein
the transportation mechanism holds a front end of the sheet-like molten resin in an extrusion direction and a rear end of the sheet-like molten resin in the extrusion direction, the sheet-like molten resin being mounted on the planar receiving base.

33. The manufacturing apparatus for the hollow body according to claim 27, wherein
the upper mold and the lower mold are arranged adjacent to each other and the upper mold and the lower mold are clamped together by turning any one of the upper mold and the lower mold.

34. The manufacturing apparatus for the hollow body according to claim 27, wherein
the planar receiving base is a conveyer.

35. The manufacturing apparatus for the hollow body according to claim 27, wherein
the sheet-like molten resin mounted on the planar receiving base has a unified length corresponding to the upper mold and the lower mold and the sheet-like molten resin is held at two positions, the two positions being a front end of the sheet-like molten resin in an extrusion direction and a rear end of the sheet-like molten resin in the extrusion direction, and the sheet-like molten resin is carried to the upper mold and the lower mold,
the unified length corresponding to the upper mold and the lower mold is a length of the sheet-like molten resin mounted from an end portion of the upper mold to an end portion of the lower mold prior to shaping.
